(19) United States
(12) Patent Application Publication
(10) Pub. No.: US 2020/0335909 A1
(43) Pub. Date: Oct. 22, 2020

(54) Connector

(71) Applicant: Yazaki Corporation, Tokyo (JP)

(72) Inventors: Kyouhei Kamimura, Tokyo (JP); Kazuto Ohtaka, Makinohara-shi (JP)

(73) Assignee: Yazaki Corporation, Tokyo (JP)

(21) Appl. No.: 16/848,346

(22) Filed: Apr. 14, 2020

(30) Foreign Application Priority Data
Apr. 16, 2019 (JP) 2019-077908

(51) Int. Cl. H01R 13/629; H01R 13/639; H01R 13/426; H01R 13/627

(52) U.S. Cl. CPC H01R 13/62955; H01R 13/639; H01R 13/6272; H01R 13/426; H01R 13/6295

(57) ABSTRACT

A female housing includes a pair of guide rails that face a connection position assurance (CPA) member in a width direction orthogonal to an insertion direction. The CPA member includes a pair of restricting portions that are positioned below the guide rails, respectively. The pair of restricting portions restrict movement of a CPA lock portion in an upward direction by coming into contact with the pair of guide rails, respectively, in a detection member moving state in which the CPA member moves between an initial position and a fitting assurance position with respect to the female housing, and release the restriction of the movement in the upward direction by the pair of guide rails in an assurance position state in which the CPA member is positioned at the fitting assurance position with respect to the female housing.

### CROSS-REFERENCE TO RELATED APPLICATION(S)

The present application claims priority to and incorporates by reference the entire contents of Japanese Patent Application No. 2019-077908 filed in Japan on Apr. 16, 2019.

### BACKGROUND OF THE INVENTION

### 1. Field of the Invention

The present invention relates to a connector.

### 2. Description of the Related Art

As a conventional connector applied to a wire harness or the like, for example, International Patent Application Laid-open No. 2010/032088 discloses a connection position assurance (CPA) connector including a male connector, a female connector, and a CPA member as a detection member slidably attached to an outer side of the female connector. In the CPA connector, by inserting a male housing into a female housing, a locked portion of the female housing enters between a locking projection portion and a separation projection portion of the male housing, and the locked portion becomes a locked state, such that the male connector is fitted to the female connector. Furthermore, in the locked state, by moving the CPA member supported by the female housing from an initial position to a fitting assurance position, a detection projection portion of the CPA member is elastically deformed, such that the CPA member sequentially overrides the locking projection portion and the locked portion, and arrives at the separation projection portion.

Here, the detection projection portion is elastically deformed in a state where the detection projection portion is in contact with the separation projection portion in an assurance position state where the CPA member moves to the fitting assurance position. Usually, there is not much opportunity to release a fitted state of the connector, and the detection projection portion thus maintains an elastically deformed state. Therefore, in a case where the connector is released from the fitted state, even though the detection member is released from the elastically deformed state by moving the detection member from the fitting assurance position in a removal direction opposite to an insertion direction, plastic deformation, that is, permanent deformation occurs.

### SUMMARY OF THE INVENTION

The present invention has been made in view of the above, and an object of the present invention is to provide a connector in which plastic deformation of a detection projection portion is suppressed in an assurance position state of a detection member.

In order to achieve the above mentioned object, a connector according to one aspect of the present invention includes a first connector housing that has a locking projection portion formed so as to protrude from an outer peripheral surface of the first connector housing; one or more first terminals that are housed in the first connector housing; a second connector housing that is fitted to the first connector housing and has a locked portion overriding the locking projection portion in a fitted state and positioned on a first direction side as compared with the locking projection portion to be locked by the locking projection portion and become a locked state; one or more second terminals that are housed in the second connector housing and are connected to the corresponding first terminals in the fitted state; and a detection member that is supported by the second connector housing to be movable at least from an initial position to a fitting assurance position in the locked state, wherein the second connector housing includes a pair of guide rails that face the detection member in a width direction orthogonal to a first direction, the detection member includes a detection projection portion that overrides the locking projection portion by elastic deformation in an upward direction of a vertical direction and is positioned on a first direction side as compared with the locking projection portion, according to movement of the detection member from the initial position to the fitting assurance position with respect to the second connector housing, the vertical direction being orthogonal to the first direction and the width direction, and a pair of restricting portions that correspond to the guide rails, respectively, and are positioned below the guide rails, and the pair of restricting portions restrict movement of the detection projection portion in an elastically deformed state in the upward direction by coming into contact with the pair of guide rails, respectively, in a detection member moving state in which the detection member moves between the initial position and the fitting assurance position with respect to the second connector housing, in the fitted state, and release the restriction of the movement in the upward direction by the pair of guide rails in an assurance position state in which the detection member is positioned at the fitting assurance position with respect to the second connector housing.

According to another aspect of the present invention, in the connector, it is possible to configure that the second connector housing has a ceiling portion formed to be positioned above the detection member housed in the second connector housing, the detection member is in contact with a contact end portion on a second direction side of the ceiling portion in the assurance position state, a second direction being an opposite direction of the first direction, and L>Lh is satisfied in which L is a distance between the contact end portion and a second direction-side end portion of the restricting portion in the assurance position state when viewed from the width direction, and Lh is a distance between the contact end portion and a first direction-side end portion of the guide rail when viewed from the width direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a connection position assurance (CPA) connector according to an embodiment;

FIG. 2 is a perspective view illustrating a male connector according to the embodiment;

FIG. 3 is a cross-sectional view illustrating the male connector according to the embodiment;

FIG. 4 is an exploded perspective view illustrating a female connector according to the embodiment;

FIG. 5 is a cross-sectional view of the female connector according to the embodiment;

FIG. 6 is a cross-sectional view of the female connector according to the embodiment;

FIG. 7 is a rear view of the female connector according to the embodiment;

FIG. 8 is a perspective view of a CPA member according to the embodiment;

FIG. 9 is a fitting explanatory diagram (initial position) of the CPA connector according to the embodiment;

FIG. 10 is a fitting explanatory diagram (initial position) of the CPA connector according to the embodiment;

FIG. 11 is a fitting explanatory diagram (fitting assurance position) of the CPA connector according to the embodiment;

FIG. 12 is a fitting explanatory diagram (fitting assurance position) of the CPA connector according to the embodiment;

FIG. 13 is a fitting explanatory diagram (temporary locking position) of the CPA connector according to the embodiment; and

FIG. 14 is a fitting explanatory diagram (temporary locking position) of the CPA connector according to the embodiment.

### DETAILED DESCRIPTION OF THE PREFERRED EMBODIMENTS

Hereinafter, an embodiment according to the present invention will be described in detail with reference to the drawings. Note that the present invention is not limited by this embodiment. In addition, components in the following embodiment include those that can be easily replaced by those skilled in the art or those that are substantially the same.

### Embodiment

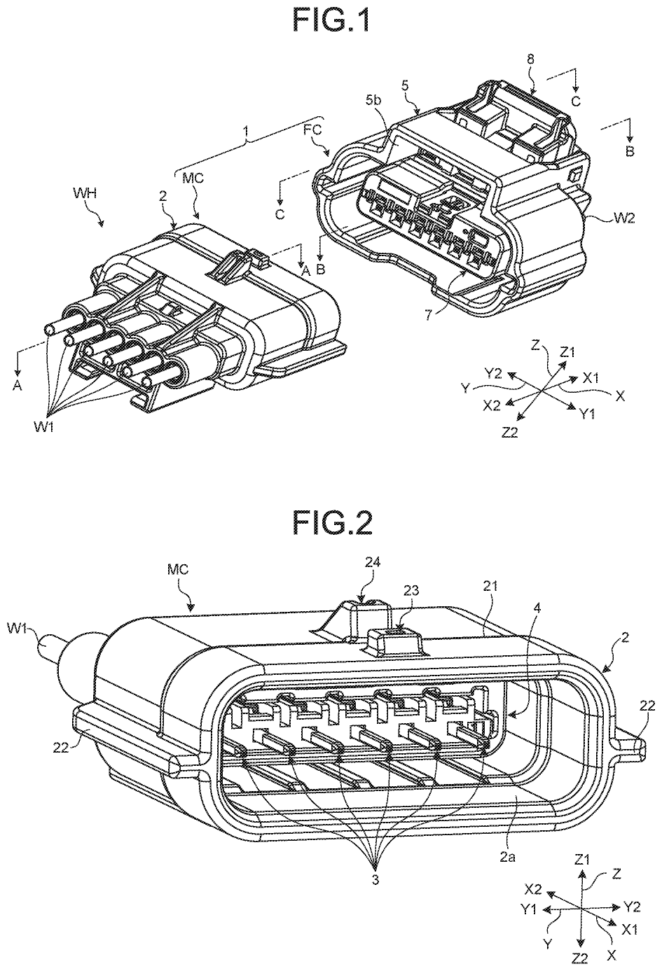

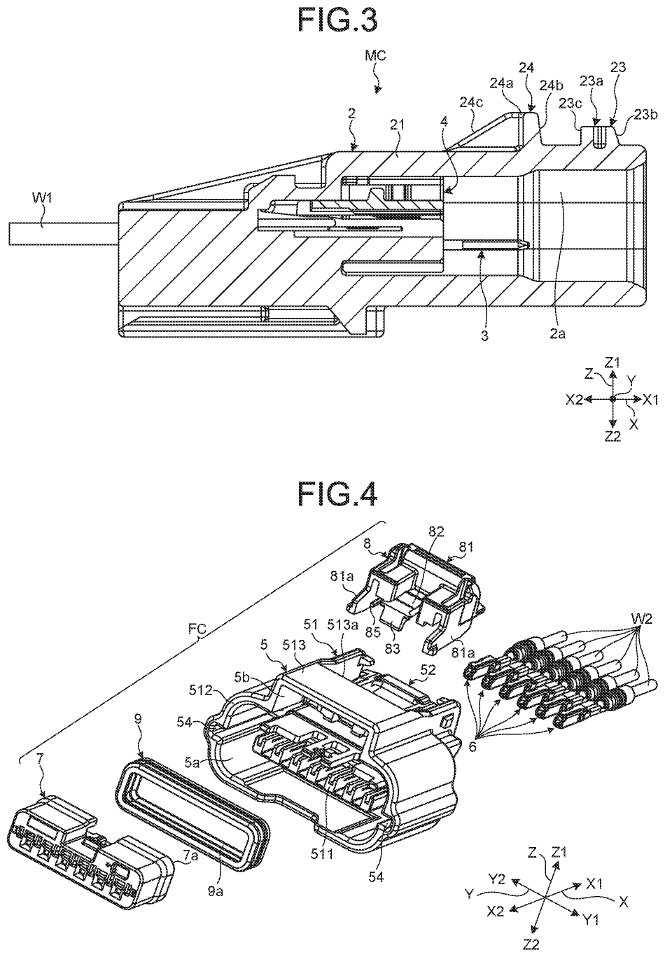

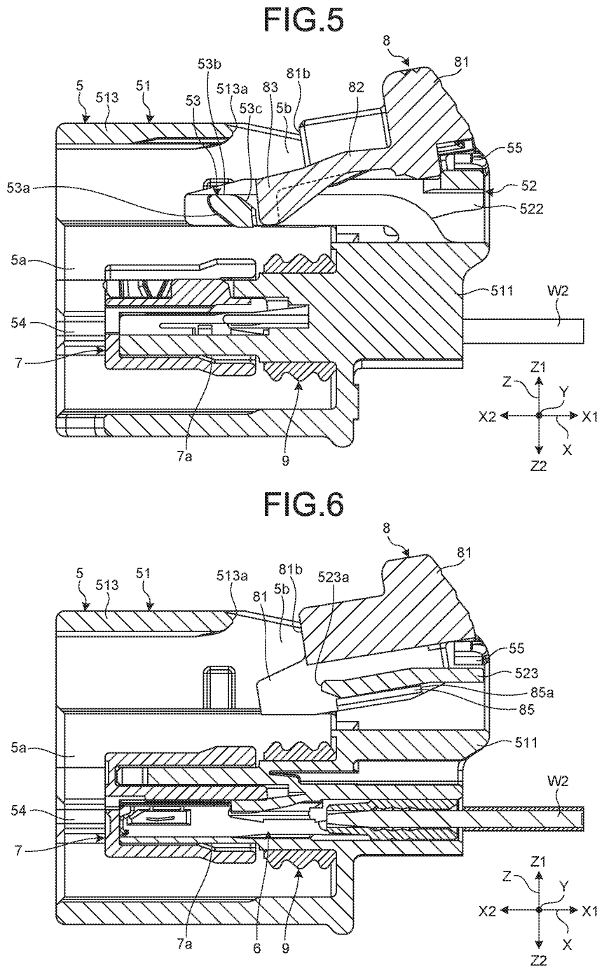

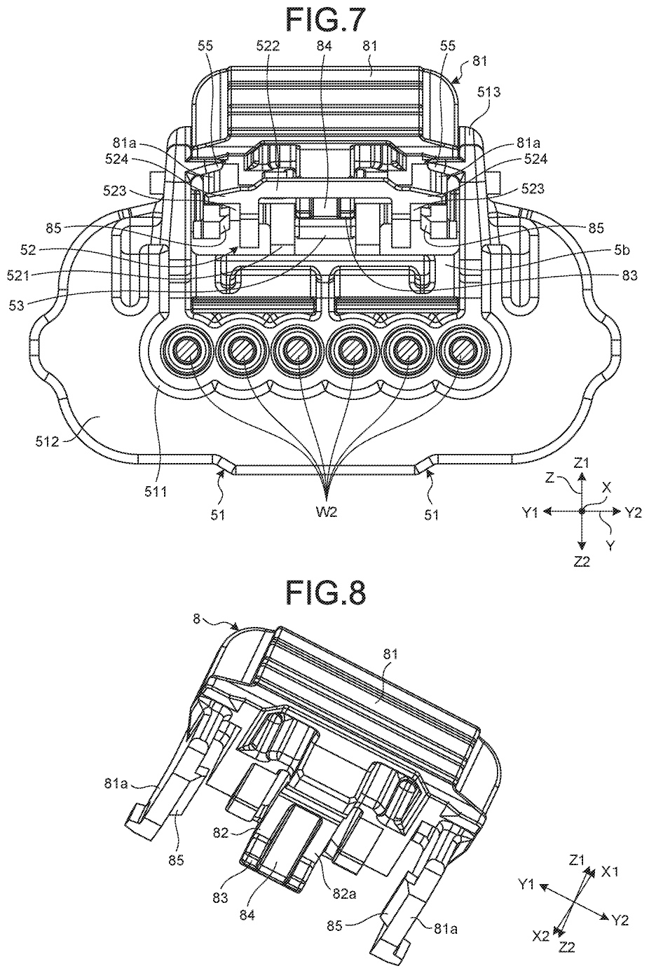

FIG. 1 is a perspective view illustrating a connection position assurance (CPA) connector according to an embodiment. FIG. 2 is a perspective view illustrating a male connector according to the embodiment. FIG. 3 is a cross-sectional view illustrating the male connector according to the embodiment. FIG. 4 is an exploded perspective view illustrating a female connector according to the embodiment. FIG. 5 is a cross-sectional view of the female connector according to the embodiment. FIG. 6 is a cross-sectional view of the female connector according to the embodiment. FIG. 7 is a rear view of the female connector according to the embodiment. FIG. 8 is a perspective view of a CPA member according to the embodiment. Note that FIG. 1 illustrates a state in which the respective elements each constituting the male connector and the female connector are assembled with each other, and FIG. 4 illustrates a state in which respective elements constituting the female connector are disassembled from each other. In addition, FIG. 3 is a cross-sectional view along line A-A of FIG. 1, FIG. 5 is a cross-sectional view along line B-B of FIG. 1, and FIG. 6 is a cross-sectional view along line C-C in FIG. 1.

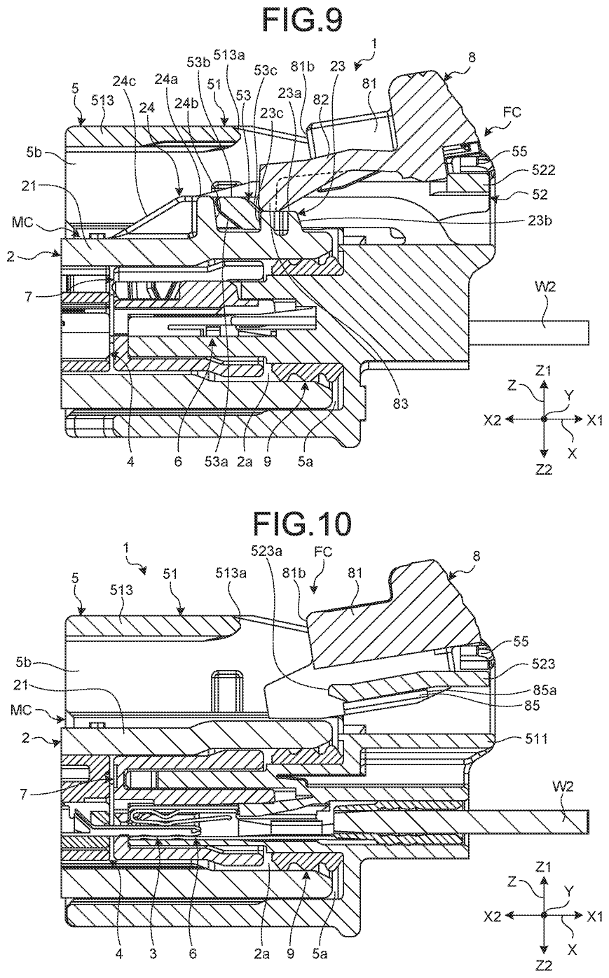

An X direction in FIGS. 1 to 8 (including FIGS. 9 to 14) is an insertion and removal direction of a CPA connector 1 according to the present embodiment, and is a front and rear direction of a male connector MC and a female connector FC. A Y direction is orthogonal to an insertion direction, and is a width direction of the CPA connector 1 according to the present embodiment. A Z direction is orthogonal to the insertion direction and the width direction, and is a vertical direction of the CPA connector 1 according to the present embodiment. An X1 direction is a second direction and is the insertion direction, and an X2 direction is a first direction and is the removal direction. A Y1 direction is a left direction, and a Y2 direction is a right direction. A Z1 direction is an upward direction, and a Z2 direction is a downward direction. Respective directions used in the following description refer to directions in a state where respective portions are assembled to each other unless otherwise specified.

The CPA connector 1 according to the present embodiment is a connector applied to, for example, a wire harness WH used for an automobile or the like. Here, the CPA connector 1 is a wire-to-wire connection mechanism that connects wires W1 and W2 constituting the wire harness WH to each other, and is used, for example, in an airbag circuit, as illustrated in FIG. 1. Here, the wires W1 and W2 are configured to include, for example, a conductor portion (core wire) obtained by twisting a plurality of conductive metal strands and an insulating coating portion that covers an outer side of the conductor portion. The CPA connector 1 includes a male connector MC and a female connector FC, and the male connector MC and the female connector FC are fitted and connector-joined to each other, such that male terminals 3 and female terminals 6 each included in the male connector MC and the female connector FC are electrically connected to each other and electrical connection portions are formed between the male connector MC and the female connector FC. Note that the wires W1 and W2 are connected to the male terminals 3 and the female terminals 6, respectively, and waterproof members are interposed between outer peripheries of the wires W1 and W2 and a terminal insertion chamber of a male housing 2 and a terminal insertion chamber of a female housing 5 described later, respectively, to secure waterproofness.

The male connector MC is a first connector, and is a male-type connector connected to distal ends of the wires W1 constituting the wire harness WH, as illustrated in FIGS. 1 to 3. The male connector MC includes the male housing 2, the male terminals 3, and a front folder 4.

The male housing 2 is a first connector housing, a male-side connector housing, and is formed of an insulating synthetic resin material or the like. The male housing 2 houses the male terminals 3, and includes a body portion 21, male-side ribs 22, a male beak 23, and a separation projection portion 24.

The body portion 21 is formed in a substantially long cylindrical shape whose removal direction side is closed, and a fitting space portion 2a is formed inside the body portion 21. The fitting space portion 2a is a space portion that communicates with the outside by an opening formed in an insertion direction-side end portion of the body portion 21 and into which the female housing 5 of the female connector FC is fitted. The body portion 21 holds the male terminals 3 through the front folder 4 so that tip portions (insertion direction-side end portions) of the male terminals 3 are exposed in the fitting space portion 2a.

The male-side ribs 22 are formed to protrude from an outer peripheral surface of the body portion 21 and extend in the insertion and removal direction. In the present embodiment, a pair of male-side ribs 22 are formed at positions facing each other in the width direction on the outer peripheral surface of the body portion 21, and are inserted, respectively, into a pair of support groove portions 54 described later of the female housing 5 at the time of connector-fitting the male connector MC and the female connector FC to each other to support the female housing 5 with respect to the male housing 2 in the vertical direction.

The male beak 23 is a locking projection portion, and is formed so as to protrude from the outer peripheral surface of the body portion 21. In the present embodiment, the male beak 23 is formed at a substantially central portion in the width direction and in the vicinity of an insertion direction-side end portion in the insertion and removal direction, on an upward direction-side surface of the outer peripheral surface of the body portion 21. In the male beak 23, when viewed from the width direction, an overridden surface 23b, which is an insertion direction side-surface, of surfaces facing each other in the insertion and removal direction with an upper surface 23a, which is a surface in the upward direction, interposed therebetween, is formed as an inclined surface that protrudes toward the insertion direction as it proceeds to the downward direction, and a locking surface 23c, which is a removal direction-side surface, of the surfaces facing each other in the insertion and removal direction, is formed in parallel (including substantially parallel) with the vertical direction. The upper surface 23a of the male beak 23 is formed to be flat, that is, in parallel with the insertion and removal direction in the present embodiment. The male beak 23 locks a female beak 53 described later of the female housing 5 on an insertion and removal direction side, and restricts the female beak 53 from moving in the insertion direction in a locked state. Here, the upper surface 23a of the male beak 23 is formed on a downward direction side of an upper surface 53b of the female beak 53 in a locked state described later in the vertical direction.

The separation projection portion 24 is formed so as to protrude from the outer peripheral surface of the body portion 21. The separation projection portion 24 is formed at a substantially central portion in the width direction on the upward direction-side surface of the outer peripheral surface of the body portion 21 to face the male beak 23 in the insertion and removal direction and to be separated from the male beak 23 on a removal direction side as compared with the male beak 23. The separation projection portion 24 is formed in a U shape in which an opening is formed on the removal direction side when viewed from the vertical direction. In the separation projection portion 24, when viewed from the width direction, is an insertion direction side-erected surface 24b of surfaces facing each other in the insertion and removal direction with an upper surface 24a, which is a surface in the upward direction, interposed therebetween, is formed in parallel (including substantially parallel) with the vertical direction, and a separation-side surface 24c, which is a removal direction-side surface, of the surfaces facing each other in the insertion and removal direction, is formed as an inclined surface that protrudes toward the removal direction as it proceeds to the downward direction. The upper surface 24a of the separation projection portion 24 is formed to be flat, that is, in parallel with the insertion and removal direction in the present embodiment. Here, the upper surface 24a of the separation projection portion 24 is formed on a straight line with the upper surface 53b of the female beak 53 in a locked state described later.

The male terminal 3 is a first terminal, and is electrically connected to the female terminal 6 by being inserted into the female terminal 6. One or more male terminals 3 are housed in the male housing 2, and a plurality of male terminals 3 are arranged and housed in the width direction in the present embodiment. The male terminal 3 is a male-type terminal fitting for a connector, is connected to a distal end of the wire W1 as illustrated in FIGS. 1 and 3, and is entirely formed of a conductive metal. The male terminal 3 extends along the insertion and removal direction in a state where the male terminal 3 is held in the male housing 2. The male terminal 3 faces the front folder 4 in the insertion and removal direction, the tip portion (tab) of the male terminal 3 protrudes from the front folder 4 to the fitting space portion 2a, and the wire W2 is connected to the other end portion (removal direction-side end portion) of the male terminal 3. Here, the terminal insertion chamber is formed so as to extend in the insertion and removal direction, and an insertion direction-side end portion of the terminal insertion chamber communicates with the fitting space portion 2a, and the terminal insertion chamber communicates with the outside by an opening formed in a removal direction-side end portion of the body portion 21. The male terminal 3 is inserted from the opening formed in the removal direction-side end portion of the body portion 21 and communicating with the terminal insertion chamber into the terminal insertion chamber along the insertion and removal direction and is locked by a lance (not illustrated), such that the male terminal 3 is held in the male housing 2 in a state where the tip portion of the male terminal is exposed into the fitting space portion 2a through the front folder 4.

The front folder 4 is attached to an insertion direction side of the male housing 2 as illustrated in FIGS. 2 and 3. The front folder 4 is inserted into the fitting space portion 2a of the male housing 2, and is held in the male housing 2 by being locked to the male housing 2 by a locking structure (not illustrated). The front folder 4 has openings formed in an insertion direction-side end portion so as to each correspond to the respective male terminals 3 facing the front folder 4 in the insertion and removal direction, and the tip portions of the respective male terminals 3 protrude from the respective openings to the fitting space portion 2a.

The female connector FC is a second connector, and is a female-type connector connected to distal ends of the wires W2 constituting the wire harness WH, as illustrated in FIGS. 1 and 4 to 7. The female connector FC includes the female housing 5, the female terminals 6, a front folder 7, a CPA member 8, and a waterproof packing 9.

The female housing 5 is a second connector housing, a female-side connector housing, is fitted to the male housing 2, and is formed of an insulating synthetic resin material or the like. The female housing 5 houses the female terminals 6 to which the male terminals 3 are connected, and can be fitted to the male housing 2 by inserting the male housing 2 into a fitting space portion 5a. The female housing 5 includes a body portion 51, a lock arm 52, the female beak 53, the support groove portions 54, and a pair of restricting projection portions 55.

The body portion 51 is formed in a substantially long cylindrical shape whose insertion direction side is closed, and is a portion that is partially inserted into the fitting space portion 2a together with the front folder 7 and is fitted to the male housing 2 by inserting a part of the male housing 2 thereinto. The body portion 51 has a fitting space portion 5a and a CPA member moving space portion 5b formed therein. The body portion 51 includes an inner body portion 511, an outer body portion 512, and a ceiling portion 513.

The inner body portion 511 is formed in a rectangular shape when viewed from the insertion and removal direction, and extends along the insertion and removal direction. The inner body portion 511 holds the female terminals 6 through the front folder 7. A terminal insertion chamber corresponding to the female terminal 6 is formed in the inner body portion 511. The terminal insertion chamber is a space portion that is formed so as to extend in the insertion and removal direction and communicates with the outside by openings formed in both end portions of the inner body portion 511 in the insertion and removal direction and into which the female terminal 6 is inserted and held from an opening on an insertion direction side along the insertion and removal direction. In the present embodiment, a plurality of terminal insertion chambers are formed in the width direction inside the inner body portion 511 according to the number of female terminals 6 provided in the female housing 5.

The outer body portion 512 is formed in a substantially long cylindrical shape whose insertion direction side along the insertion and removal direction is closed, and the fitting space portion 5a is formed inside the outer body portion 512. The outer body portion 512 is connected to the inner body portion 511 at an insertion direction-side end portion, and is formed integrally with the inner body portion 511 in the present embodiment. The outer body portion 512 is formed so that both end portions thereof in the width direction are separated from each other in the width direction and protrude toward the upward direction. The outer body portion 512 is connected to the ceiling portion 513, and is formed integrally with the ceiling portion 513 in the present embodiment. The both end portions of the outer body portion 512 in the width direction are formed so as to communicate with the outside by openings formed in both end portions in the insertion and removal direction and communicate with the outside formed above an insertion direction-side end portion except for the ceiling portion 513. The fitting space portion 5a is a space portion that communicates with the outside by an opening formed in a removal direction-side end portion of the outer body portion 512 and into which the male housing 2 of the male connector MC is fitted.

The ceiling portion 513 is positioned above the CPA member 8 housed in the female housing 5. In the present embodiment, the ceiling portion 513 is formed in a plate shape. The ceiling portion 513 forms the CPA member moving space portion 5b together with the both end portions of the outer body portion 512 in the width direction. The CPA member moving space portion 5b is a space portion into which the CPA member 8 is inserted and which supports the CPA member 8 so as to be movable in the insertion and removal direction. Here, the ceiling portion 513 is formed so as to face the CPA member 8 when viewed from the insertion and removal direction. That is, when the CPA member 8 moves in the removal direction with respect to the female housing 5, a contact end portion 513a on an insertion direction side of the ceiling portion 513 is in contact with the CPA member 8 to restrict movement of the CPA member 8 in the removal direction. Here, the ceiling portion 513 is formed so that the contact end portion 513a thereof is in contact with the CPA member 8 in an assurance position state where the CPA member 8 is positioned at a fitting assurance position.

The lock arm 52 supports the female beak 53 in a state where the female beak 53 is separated from the body portion 51 in the vertical direction. The lock arm 52 includes a first arm portion 521, a second arm portion 522, and a pair of guide rails 523 and 523. The first arm portion 521 is formed in a U shape whose insertion direction side is opened when viewed from the vertical direction. The first arm portion 521 has both end portions on an insertion direction side connected to the inner body portion 511, and supports the lock arm 52 so as to be elastically deformable with respect to the body portion 51. The female beak 53 is formed at a central portion of a removal direction-side end portion of the first arm portion 521 in the width direction. Therefore, the first arm portion 521 is elastically deformed in the vertical direction to support the female beak 53 so as to be movable in the vertical direction with respect to the inner body portion 511. The second arm portion 522 is formed in a U shape whose removal direction side is opened when viewed from the vertical direction. The second arm portion 522 has both end portions on a removal direction side (two end portions in the width direction) connected to both end portions on a removal direction side of the first arm portion 521, respectively. The guide rails 523 and 523 are formed at both end portions of the second arm portion 522 in the width direction, respectively, so as to protrude outward.

The pair of guide rails 523 and 523 face the CPA member 8 in the width direction, and support movement of the CPA member 8 in the insertion and removal direction with respect to the female housing 5. An insertion direction side of the guide rail 523 is formed along the insertion and removal direction, and a removal direction side of the guide rail 523 is formed so as to be inclined (toward the downward direction as it proceeds to the removal direction). In addition, a rail protrusion portion 524 that protrudes outward in the width direction is formed at an insertion direction-side end portion of the guide rail 523. When the CPA member 8 moves in the insertion direction with respect to the female housing 5, the rail protrusion portion 524 comes into contact with the CPA member 8 to restrict movement of the CPA member 8 in the insertion direction. Here, since the pair of guide rails 523 and 523 are formed in the lock arm 52, the first arm portion 521 and the second arm portion 522 are elastically deformed in the vertical direction, such that the CPA member 8 is movable.

The female beak 53 is a locked portion, and overrides the male beak 23 in the upward direction, enters between the male beak 23 and the separation projection portion 24 in the insertion and removal direction, and is locked in the insertion and removal direction by the male beak 23 and the separation projection portion 24, in a fitted state where the male housing 2 is inserted and fitted to the female housing 5 in the insertion direction. The female beak 53 becomes a locked state by being locked in the insertion and removal direction by the male beak 23. In the present embodiment, the female beak 53 is formed so as to protrude toward the downward direction at a removal direction-side end portion of the lock arm 52. The female beak 53 has an overriding surface 53a formed at a removal direction-side end portion of both end portions thereof in the insertion and removal direction, when viewed from the width direction. In the present embodiment, the overriding surface 53a is formed as an inclined surface that faces, in the vertical direction, the upper surface 53b of both surfaces in the vertical direction and is recessed toward the insertion direction as it proceeds to the downward direction. The upper surface 53b is formed in parallel with the insertion and removal direction. The female beak 53 has a guide surface 53c formed at an insertion direction-side end portion of the both end portions thereof in the insertion and removal direction and continuous with the upper surface 53b. The guide surface 53c is formed as an inclined surface that protrudes from the upper surface 23a of the male beak 23 and protrudes toward the removal direction as it proceeds toward the upward direction, when viewed from the insertion and removal direction. The guide surface 53c is formed so that the removal direction-side end portion is continuous with an insertion direction-side end portion of the upper surface 53b.

The support groove portions 54 are formed along the insertion and removal direction in the fitting space portion 5a, and a plurality of support groove portions 54 are formed so as to correspond to the pair of male-side ribs 22, respectively.

The pair of restricting projection portions 55 is overridden by the CPA member 8 at an initial position to restrict the movement of the CPA member 8 in the insertion direction. The pair of restricting projection portions 55 are formed on an upward direction-side end portion and an insertion direction-side end portion of both end portions of the outer body portion 512 in the width direction, respectively. The restricting projection portions 55 are formed so as to protrude inward, that is, toward the CPA member moving space portion 5b, respectively.

The female terminal 6 is a second terminal, and is electrically connected to the male terminal 3 by inserting the male terminal 3 thereinto. One or more female terminals 6 are housed in the female housing 5, and a plurality of female terminals 6 are arranged and housed in the width direction in the present embodiment. The female terminal 6 is a female-type terminal fitting for a connector, is connected to a distal end of the wire W2 as illustrated in FIGS. 4 and 5, and is entirely formed of a conductive metal. The female terminal 6 extends along the insertion and removal direction in a state where the female terminal 6 is held in the female housing 5. The female terminal 6 has a tip portion facing the front folder 7 in the insertion and removal direction, and the wire W2 is connected to an end portion (insertion direction-side end portion) of the female terminal 6 opposite to the tip portion. The female terminal 6 is inserted from an opening formed in an insertion direction-side end portion of the inner body portion 511 into the terminal insertion chamber along the insertion and removal direction, and is held in the female housing 5 by being locked by a lance (not illustrated). An insertion space portion is formed in the female terminal 6. The insertion space portion is a space portion that is formed to extend in the insertion and removal direction and communicates with the outside by an opening formed in a removal direction side of the female terminal 6 and into which the tip portion of the male terminal 3 is inserted and held along the insertion and removal direction.

The front folder 7 has an insertion space portion 7a into which a part of the female housing 5 is inserted to restrict movement of the female terminal 6 in the removal direction, as illustrated in FIGS. 1 and 4 to 6. The front folder 7 is attached to a removal direction-side end portion of the inner body portion 511, and covers a removal direction side of the inner body portion 511.

The CPA member 8 is a detection member for detecting that the male housing 2 and the female housing 5 are completely fitted to each other, and is a member for realizing a so-called CPA (connector position assurance). The CPA member 8 is inserted into the CPA member moving space portion 5b of the female housing 5, and is supported by the female housing 5 so as to be movable relative to the female housing 5 in the insertion and removal direction. The CPA member 8 can move from the initial position to a fitting assurance position and from the fitting assurance position to a temporary locking position in the insertion and removal direction with respect to the female housing 5, in a fitted state (locked state). Here, the initial position is a position where the CPA member 8 moves to an insertion direction-side end portion with respect to the female housing 5 in the fitted state, and is in a state where the CPA member 8 overrides the restricting projection portions 55 in the present embodiment. In addition, the fitting assurance position is a position where the CPA member 8 moves to a removal direction-side end portion with respect to the female housing 5 in the fitted state, and is a position where a CPA lock portion 83 described later faces the separation projection portion 24 in the insertion and removal direction. The temporary locking position is a position where the CPA member 8 moves to the insertion direction-side end portion with respect to the female housing 5 in the fitted state or a non-fitted state, and is in a state where the CPA member 8 does not override the restricting projection portions 55 in the present embodiment.

The CPA member 8 is formed of an insulating synthetic resin material or the like, and includes a body portion 81, a lock arm 82, the CPA lock portion 83, a rib 84, and a pair of restricting portions 85, as illustrated in FIGS. 1 and 4 to 8.

The body portion 81 is formed in a U shape whose removal direction side is opened when viewed from the vertical direction. The body portion 81 is formed in a U shape whose downward direction side is opened also when viewed from the insertion and removal direction, and includes a pair of leg portions 81a and 81a formed so as to extend in the downward direction. The body portion 81 has an insertion direction-side end portion formed so as to protrude toward the upward direction, and has an operation surface.

The lock arm 82 supports the CPA lock portion 83 so as to be elastically deformable in the vertical direction with respect to the body portion 81. The lock arm 82 is a plate-shaped member, and an insertion direction-side end portion of both end portions of the lock arm 82 in the insertion and removal direction is connected to the body portion 81 so as to be elastically deformable in the vertical direction with respect to the body portion 81.

The CPA lock portion 83 is a detection projection portion, sequentially overrides the male beak 23 and the female beak 53 according to the movement of the CPA member 8 from the initial position to the fitting assurance position in the locked state, and faces the separation projection portion 24 in the insertion and removal direction at the fitting assurance position. The CPA lock portion 83 is formed at a removal direction-side end portion of both end portions of the lock arm 82 in the insertion and removal direction. In the present embodiment, the CPA lock portion 83 is formed so as to protrude from a removal direction-side end portion of a lower surface 82a of both surfaces of the lock arm 82 in the vertical direction toward the downward direction.

The rib 84 is formed so as to protrude from the lower surface 82a of the lock arm 82 toward the downward direction. The rib 84 is formed continuously with the CPA lock portion 83. In the present embodiment, the rib 84 is formed so as to protrude from a center portion of the lower surface 82a in the width direction toward the downward direction, and has a removal direction-side end portion connected to the removal direction-side end portion of the CPA lock portion 83. A downward direction-side surface of the rib 84 is formed integrally with a downward direction-side surface of the CPA lock portion 83, when viewed from the width direction.

The pair of restricting portions 85 and 85 correspond to the pair of guide rails 523 and 523, respectively, are positioned below the guide rails 523, and support the CPA member 8 with respect to the female housing 5. The pair of restricting portions 85 and 85 are formed at both end portions of the body portion 81 in the width direction, respectively. In the present embodiment, the pair of restricting portions 85 and 85 are formed on the leg portions 81a and 81a, respectively. The restricting portions 85 are formed so as to protrude inward, that is, toward the lock arm 82, respectively. The restricting portion 85 is formed so as to extend in the insertion and removal direction, and a length of the restricting portion 85 in the insertion and removal direction is shorter than that of the guide rail 523 in the insertion and removal direction. The pair of restricting portions 85 embrace the pair of guide rails 523 and 523, respectively, when the CPA member 8 is inserted into the female housing 5, and are positioned below the pair of guide rails 523 and 523 to permit movement of the CPA member 8 in the insertion and removal direction with respect to the female housing 5 while restricting movement of the CPA member 8 in the upward direction with respect to the female housing 5.

Here, the pair of restricting portions 85 and 85 are formed so as to restrict movement of the detection projection portion in an elastically deformed state in the upward direction by coming into contact with the pair of guide rails 523 and 523, respectively, in a detection member moving state in which the CPA member 8 moves between the initial position and the fitting assurance position with respect to the female housing 5 in the fitted state. In addition, the pair of restricting portions 85 and 85 is formed so as to release the restriction of the movement in the upward direction by the pair of guide rails 523 and 523 in the assurance position state in which the CPA member 8 is positioned at the fitting assurance position with respect to the female housing 5. Specifically, the restricting portion 85 is formed so as to extend in the insertion and removal direction, and the length of the restricting portion 85 in the insertion and removal direction is shorter than that of the guide rail 523 in the insertion and removal direction. That is, the pair of restricting portions 85 and 85 and the pair of guide rails 523 and 523 are formed so that the CPA member 8 is rotatable around the width direction with respect to the female housing 5 in the assurance position state.

The waterproof packing 9 is interposed in a gap between the male housing 2 and the female housing 5 in the fitted state, as illustrated in FIG. 2, to suppress infiltration of a liquid such as water from the outside into the fitting space portion 2a. The waterproof packing 9 is formed in a ring shape, and the inner body portion 511 of the female housing 5 is inserted along the insertion and removal direction into an insertion space portion 9a formed in the waterproof packing 9.

Next, assembly, that is, fitting, of the CPA connector 1 will be described. Assembly of the male connector MC will be described. First, a worker inserts the male terminals 3 to which the wires W1 are connected from the opening formed in the removal direction-side end portion of the body portion 21 into the respective terminal insertion chambers, respectively, locks the respective inserted male terminals 3 by the lance, and holds the respective male terminals 3 inside the male housing 2 to assemble the respective male terminals 3 to the male housing 2, as illustrated in FIGS. 2 and 3. Next, the worker inserts the front folder 4 from the insertion direction-side end portion of the male housing 2 into the fitting space portion 2a, and holds the front folder 4 in the body portion 21 in the fitting space portion 2a to assemble the front folder 4 to the male housing 2.

Next, assembly of the female connector FC will be described. First, a worker inserts the respective female terminals 6 to which the wires W2 are connected from the opening formed in the insertion direction-side end portion of the inner body portion 511 into the respective terminal insertion chambers, respectively, locks the respective inserted female terminals 6 by the lance, and holds the respective female terminals 6 inside the female housing 5 to assemble the respective female terminals 6 to the female housing 5, as illustrated in FIGS. 4 and 5. Next, the worker inserts the waterproof packing 9 from the removal direction-side end portion of the outer body portion 512 into the fitting space portion 5a and inserts the inner body portion 511 into the insertion space portion 9a to hold the waterproof packing 9 by the inner body portion 511, thereby assembling the waterproof packing 9 to the female housing 5. Next, the worker inserts the front folder 7 from the removal direction-side end portion of the outer body portion 512 into the fitting space portion 5a and inserts the inner body portion 511 from the insertion direction-side end portion of the front folder 7 into the insertion space portion 7a to hold the front folder 7 in the body portion 51 in the fitting space portion 5a, thereby assembling the front folder 7 to the male housing 2.

Next, the worker inserts the CPA member 8 into the CPA member moving space portion 5b of the female housing 5 to assemble the CPA member 8 into the female housing 5. At this time, the CPA member 8 is assembled in a state where the pair of restricting portions 85 embrace the pair of guide rails 523 and 523 of the lock arm 52 and the CPA member 8 overrides the pair of restricting projection portions 55 and is positioned at a transport position. At the transport position, as illustrated in FIG. 5, the pair of restricting projection portions 55 and the body portion 81 face each other in the insertion and removal direction, such that the movement of the CPA member 8 in the insertion direction with respect to the female housing 5 is restricted. In addition, the female beak 53 and the CPA lock portion 83 face each other in the insertion and removal direction, such that the movement of the CPA member 8 in the removal direction with respect to the female housing 5 is restricted. In addition, at the transport position, as illustrated in FIG. 6, the pair of restricting portions 85 and 85 are positioned below the pair of guide rails 523 and 523.

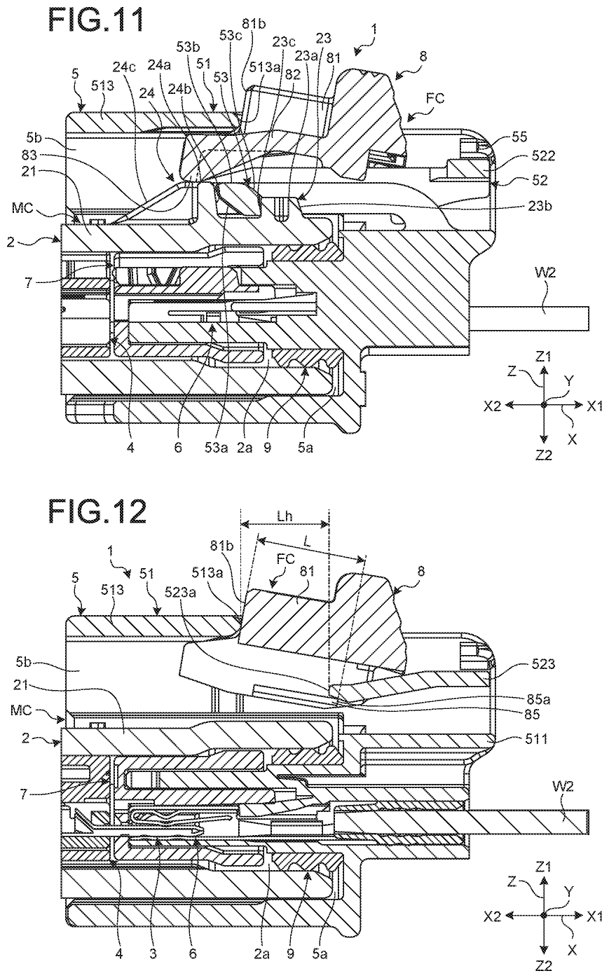

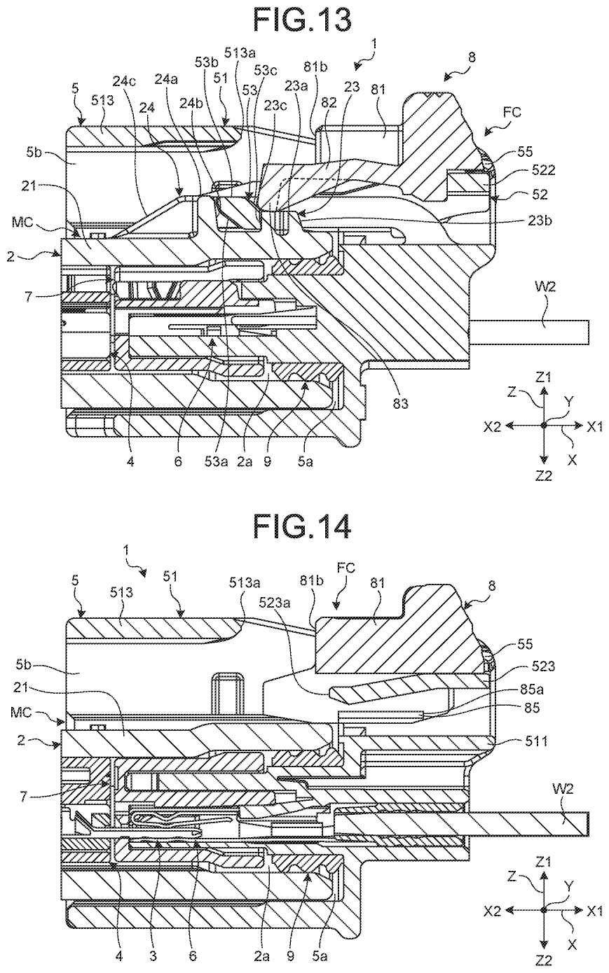

Next, the worker assembles the male connector MC to the female connector FC. FIG. 9 is a fitting explanatory diagram (initial position) of the CPA connector according to the embodiment. FIG. 10 is a fitting explanatory diagram (initial position) of the CPA connector according to the embodiment. FIG. 11 is a fitting explanatory diagram (fitting assurance position) of the CPA connector according to the embodiment. FIG. 12 is a fitting explanatory diagram (fitting assurance position) of the CPA connector according to the embodiment. FIG. 13 is a fitting explanatory diagram (temporary locking position) of the CPA connector according to the embodiment. FIG. 14 is a fitting explanatory diagram (temporary locking position) of the CPA connector according to the embodiment.

The worker inserts the inner body portion 511 of the female housing 5 into the fitting space portion 2a of the male housing 2 and inserts the male housing 2 into the fitting space portion 5a of the female housing 5, in a state where the CPA member 8 is at the initial position. Here, when the insertion of the male housing 2 into the female housing 5 in the insertion direction is started, first, the tip portions of the male terminals 3 housed in the male housing 2 are inserted into the insertion space portions of the female terminals 6 housed in the female housing 5, such that an insertion force is first generated as a fitting force. Next, after connection between the male terminal 3 and the female terminal 6 is started, the male beak 23 and the female beak 53 face each other in a state of being separated from each other in the insertion and removal direction. Next, after the male beak 23 and the female beak 53 face each other in the insertion and removal direction, the overriding surface 53a of the female beak 53 and the overridden surface 23b of the male beak 23 come into contact with each other. The female beak 53 is elastically deformed in the upward direction while the overriding surface 53a is in contact with the overridden surface 23b, thereby overriding the upper surface 23a of the male beak 23. The female beak 53 moves on the upper surface 23a of the male beak 23 in the removal direction and is elastically returned to enter between the male beak 23 and the separation projection portion 24. Thus, as illustrated in FIG. 9, the female beak 53 is positioned between the male beak 23 and the separation projection portion 24, becomes in a locked state, and the male housing 2 and the female housing 5 are in a fitted state.

Next, the worker moves the CPA member 8 from the initial position in the removal direction with respect to the female housing 5 in the locked state to move the CPA member 8 to the fitting assurance position. The CPA lock portion 83 of the CPA member 8 is in contact with the upper surface 23a of the male beak 23 at the initial position of the CPA member 8. The CPA member 8 moves on the upper surface 23a of the male beak 23 in the removal direction, such that the CPA lock portion 83 and the guide surface 53c of the female beak 53 come into contact with each other. The CPA lock portion 83 moves in the removal direction while being in contact with the guide surface 53c, such that the lock arm 82 is elastically deformed in the upward direction to override the upper surface 53b of the female beak 53. Furthermore, the CPA lock portion 83 moves on the upper surface 53b of the female beak 53 in the removal direction and transfers from the upper surface 53b to the upper surface 24a of the separation projection portion 24, such that the contact end portion 513a comes into contact with a removal direction-side end portion 81b of the body portion 81 of the CPA member 8. The CPA member 8 moves from the initial position to the fitting assurance position on the condition that the CPA member 8 is in the fitted state, such that it is possible to detect a fitting between the female connector FC and the male connector MC and the fitting is assured. Here, in the detection member moving state in which the CPA member 8 moves from the initial position to the fitting assurance position with respect to the female housing 5, the pair of restricting portions 85 and 85 are positioned below the pair of guide rails 523 and 523 and come into contact with the pair of guide rails 523 and 523, and the CPA lock portion 83 that is in an elastically deformed state is thus restricted from moving in the upward direction.

In addition, in the assurance position state where the CPA member 8 is positioned at the fitting assurance position, the pair of restricting portions 85 and 85 releases the restriction of the movement in the upward direction by the pair of guide rails 523 and 523. That is, in the assurance position state, the CPA member 8 becomes rotatable around the width direction with respect to the female housing 5. On the other hand, in the assurance position state, the CPA lock portion 83 is in contact with the separation projection portion 24 in the elastically deformed state. Therefore, the CPA lock portion 83 can be elastically returned because the rotation of the CPA member 8 with respect to the female housing 5 is permitted. Thus, as illustrated in FIGS. 11 and 12, the CPA member 8 rotates in the upward direction with respect to the female housing 5, and the elastic deformation of the CPA lock portion 83 is suppressed the elastically deformed state of the CPA lock portion 83 as compared with a state before the rotation, or the elastically deformed state of the CPA lock portion 83 is released when the CPA member 8 can rotate in the upward direction with respect to the female housing 5 until the CPA lock portion 83 can be completely elastically returned.

Here, the pair of restricting portions 85 and 85 and the pair of guide rails 523 and 523 are formed so that a distance L between the contact end portion 513a and insertion direction-side end portions 85a of the pair of restricting portions 85 and 85 in the assurance position state when viewed from the width direction is larger than a distance Lh between the contact end portion 513a and removal direction-side end portions 523a and 523a of the pair of guide rails 523 and 523 (L>Lh) when viewed from the width direction. Therefore, in the assurance position state, the end portions 85a of the pair of restricting portions 85 and 85 and the end portions 523a of the pair of guide rails 523 and 523 face each other in the vertical direction. That is, in the assurance position state, even though the CPA member 8 rotates in the upward direction with respect to the female housing 5, parts of the pair of restricting portions 85 and 85 are positioned below the guide rails 523 and 523, and parts of the pair of restricting portions 85 and 85 are caught by the guide rails 523 and 523.

The worker moves the CPA member 8 from the fitting assurance position to the temporary locking position, for example, when releasing the fitted state between the male housing 2 and the female housing 5. The worker moves the CPA member 8 rotating in the upward direction with respect to the female housing 5 in the insertion direction at the fitting assurance position. At this time, the CPA member 8 rotates in the downward direction with respect to the female housing 5 while moving in the insertion direction with respect to the female housing 5 because parts of the pair of restricting portions 85 and 85 are positioned below the guide rails 523 and 523. Therefore, when the CPA member 8 moves from the fitting assurance position in the insertion direction, the CPA lock portion 83 moves on the upper surface 24a of the separation projection portion 24 in the insertion direction, transfers from the upper surface 24a to the upper surface 53b of the female beak 53, moves on the upper surface 53b in the insertion direction, transfers to the guide surface 53c, moves on the guide surface 53c in the insertion direction, and transfers to the upper surface 23a of the male beak 23, in the elastically deformed state, to allow an insertion direction-side end portion of the body portion 81 to come into contact with the second arm portion 522, such that the CPA member 8 moves to the temporary locking position, as illustrated in FIGS. 13 and 14. Here, in the detection member moving state in which the CPA member 8 moves from the fitting assurance position to the temporary locking position with respect to the female housing 5, the pair of restricting portions 85 and 85 are positioned below the pair of guide rails 523 and 523 and come into contact with the pair of guide rails 523 and 523, and the CPA lock portion 83 that is in an elastically deformed state is thus restricted from moving in the upward direction.

As described above, according to the CPA connector 1 according to the present embodiment, in the fitted state, in the detection member moving state, the pair of restricting portions 85 and 85 come into contact with the pair of guide rails 523 and 523, respectively, to restrict movement of the CPA lock portion 83 in the elastically deformed state in the upward direction, and in the assurance position state, the restriction on the movement of the pair of restricting portions 85 and 85 in the upward direction with respect to the pair of guide rails 523 and 523 is released, and the CPA lock portion 83 can thus be elastically returned from the elastically deformed state, such that it is possible to suppress plastic deformation of the CPA lock portion 83 in the assurance position state of the CPA member 8. Thus, even though the CPA member 8 is moved from the fitting assurance position to the temporary locking position and is again moved from the temporary locking position to the fitting assurance position, the plastic deformation of the CPA lock portion 83 can be suppressed. Therefore, even though the CPA member 8 repeatedly moves from the fitting assurance position, it is possible to suppress deterioration of a function as the CPA member 8. In addition, since the plastic deformation of the CPA lock portion 83 can be suppressed in the assurance position state, for the purpose of reducing the elastically deformed state of the CPA lock portion 83, it is possible to suppress an increase in a stroke amount of the CPA lock portion 83 from the initial position to the fitting assurance position. For example, when a position where the CPA lock portion 83 is moved to the separation-side surface 24c (inclined surface) of the separation projection portion 24 that can reduce the elastically deformed state of the CPA lock portion 83 as compared with the upper surface 24a of the separation projection portion 24 is defined as the fitting assurance position in order to reduce the elastically deformed state of the CPA lock portion 83, the stroke amount of the CPA lock portion 83 from the initial position to the fitting assurance position increases, but if the CPA lock portion 83 can be elastically returned at the fitting assurance position, it is possible to suppress the increase in the stroke amount of the CPA lock portion 83.

In addition, in the CPA connector 1 according to the present embodiment, when viewed from the width direction, the distance L between the contact end portion 513a and the end portion 85a is larger than the distance Lh between the contact end portion 513a and the end portion 523a. Therefore, when the CPA member 8 is moved from the fitting assurance position to the temporary locking position, an operation of positioning the pair of restricting portions 85 and 85 below the pair of guide rails 523 and 523 is not necessary. Therefore, it is possible to easily move the CPA member 8 from the fitting assurance position to the temporary locking position.

According to the present embodiment, in the assurance position state of the detection member, the restriction of the movement in the upward direction by the pair of guide rails for the pair of restricting portions is released, and the detection projection portion can thus be elastically returned from the elastically deformed state, such that it is possible to suppress plastic deformation of the detection projection portion in the assurance position state of the detection member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a first connector housing that has a locking projection portion formed so as to protrude from an outer peripheral surface of the first connector housing;
one or more first terminals that are housed in the first connector housing;
a second connector housing that is fitted to the first connector housing and has a locked portion overriding the locking projection portion in a fitted state and positioned on a first direction side as compared with the locking projection portion to be locked by the locking projection portion and become a locked state;
one or more second terminals that are housed in the second connector housing and are connected to the corresponding first terminals in the fitted state; and
a detection member that is supported by the second connector housing to be movable at least from an initial position to a fitting assurance position in the locked state, wherein
the second connector housing includes a pair of guide rails that face the detection member in a width direction orthogonal to a first direction,
the detection member includes
a detection projection portion that overrides the locking projection portion by elastic deformation in an upward direction of a vertical direction and is positioned on a first direction side as compared with the locking projection portion, according to movement of the detection member from the initial position to the fitting assurance position with respect to the second connector housing, the vertical direction being orthogonal to the first direction and the width direction, and
a pair of restricting portions that correspond to the guide rails, respectively, and are positioned below the guide rails, and
the pair of restricting portions
restrict movement of the detection projection portion in an elastically deformed state in the upward direction by coming into contact with the pair of guide rails, respectively, in a detection member moving state in which the detection member moves between the initial position and the fitting assurance position with respect to the second connector housing, in the fitted state, and
release the restriction of the movement in the upward direction by the pair of guide rails in an assurance position state in which the detection member is positioned at the fitting assurance position with respect to the second connector housing.

2. The connector according to claim 1, wherein
the second connector housing has a ceiling portion formed to be positioned above the detection member housed in the second connector housing,
the detection member is in contact with a contact end portion on a second direction side of the ceiling portion in the assurance position state, the second direction being an opposite direction of the first direction, and
L>Lh is satisfied in which L is a distance between the contact end portion and a second direction-side end portion of the restricting portion in the assurance position state when viewed from the width direction, and Lh is a distance between the contact end portion and a first direction-side end portion of the guide rail when viewed from the width direction.
